(19) United States
(12) Patent Application Publication
(10) Pub. No.: US 2006/0038507 A1
(43) Pub. Date: Feb. 23, 2006

(54) Flat lamp having photocatalytic layer

(75) Inventors: Seong-eui Lee, Gyeonggi-do (KR); Hidekazu Hatanaka, Gyeonggi-do (KR); Young-mo Kim, Gyeonggi-do (KR); Ho-nyeon Lee, Gyeonggi-do (KR); Sang-hun Jang, Gyeonggi-do (KR); Seung-hyun Son, Gyeonggi-do (KR); Gi-young Kim, Gyeonggi-do (KR); Hyoung-bin Park, Gyeonggi-do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Corning Co., Ltd., Gyeonggi-do (KR)

(21) Appl. No.: 11/201,146

(22) Filed: Aug. 11, 2005

(30) Foreign Application Priority Data
Aug. 17, 2004 (KR) 10-2004-0064587

(51) Int. Cl. H05B 41/16; H05B 41/24

(52) U.S. Cl. 315/267; 422/186.3

(57) ABSTRACT

Provided is a flat panel having a photocatalytic layer. The flat panel may include a bottom substrate; a plurality of barrier ribs on the bottom substrate; a top substrate separated from the bottom substrate by the barrier ribs with a discharge space surrounded by the bottom substrate, the top substrate and the barrier ribs; a plurality of discharge electrodes formed on one side of the top substrate, one side of the bottom substrate, or one side of each of the top substrate and the bottom substrate; a photocatalytic layer which may be formed on at least one of the inner surfaces of the discharge space and generates electrons and holes in response to UV light generated during discharge; and a fluorescent layer which may be formed on the photocatalytic layer and generates visible light in response to the UV light generated during the discharge.

This application claims the benefit of Korean Patent Application No. 10-2004-0064587, filed on Aug. 17, 2004, in the Korean Intellectual Property Office, the disclosure of which is incorporated herein in its entirety by reference.

### BACKGROUND OF THE DISCLOSURE

1. Field of the Disclosure

Embodiments of the present disclosure may relate to a flat lamp, and more particularly, to a flat lamp which may have increased discharge efficiency and brightness and can utilize UV light in a discharge space in an efficient manner.

2. Description of the Related Art

With rapid development of technology in the field of displays, cathode ray tubes (CRTs) have been replaced with flat panel displays having new driving modes. Such flat panel displays include liquid crystal displays (LCDs), plasma display panels (PDPs), field emission displays (FEDs), etc.

LCDs are electronic devices which display pictures using the change in transmittance of liquid crystals according to an applied voltage. Specifically, LCDs have liquid crystals injected into a space between two sheets of glass. When electric power is applied to electrodes installed on the two sheets of glass, a molecular arrangement of the liquid crystals is changed and the liquid crystals transmit light, thus displaying a predetermined picture.

Generally, an LCD comprises an LCD panel unit, a driving unit, and a back-light unit.

As opposed to CRTs, LCDs do not have self-luminescence. Thus, backlights as light sources are installed on the backside of LCD panels. Flat lamps are used as backlights and there exist surface discharge type flat lamps and facing discharge type flat lamps.

More recently the technical developments of flat lamps have been focused on making flat lamps thinner, brighter, and having lower electric power consumption.

Flat lamps have adopted a direct current structure. In the direct current type structure, a fluorescent layer is coated on a top substrate and a bottom substrate, a discharge gas is injected in a discharge space between the top and bottom substrates which is sealed, and electrodes covered with dielectric layers are disposed in the discharge space between the substrates.

FIG. 1 is a partial perspective view of a conventional flat lamp.

Referring to FIG. 1, a bottom substrate 10 and a top substrate 20 are separated by a plurality of barrier ribs 19 formed between the bottom substrate 10 and the top substrate 20. A discharge space 11 is surrounded by the bottom substrate 10, the top substrate 20, and the barrier ribs 19.

The discharge space 11 is filled with a discharge gas which is a mixture of neon (Ne) gas and xenon (Xe) gas. Gas discharge occurs in the discharge space 11.

A fluorescent layer 14 is formed on the top surface of the bottom substrate 10, the lateral surfaces of the barrier ribs 19, and the bottom surface of the top substrate 20. The fluorescent layer 14 is excited by UV light which is generated during the gas discharge, producing a visible light.

A reflective layer 13 is formed between the bottom substrate 10 and the fluorescent layer 14. The visible light produced in the discharge space 11 is reflected by the reflective layer 13, thus increasing light efficiency.

A plurality of discharge electrodes for the gas discharge are formed on the bottom substrate 10 and the top substrate 20. Specifically, bottom electrodes 12 and top electrodes 22 are respectively formed on the bottom surface of the bottom substrate 10 and the top surface of the top substrate 20.

The bottom electrodes 12 include first bottom electrodes 12a and second bottom electrodes 12b. When a predetermined electrical potential difference is applied between one of the first bottom electrodes 12a and the corresponding second bottom electrode 12b, surface discharge may be induced in the discharge space 11. Similarly, the top electrodes 22 include first top electrodes 22a and second top electrodes 22b. When a predetermined electrical potential difference is applied between one of the first top electrodes 22a and the corresponding second top electrode 22b, surface discharge may be induced in the discharge space 11.

In the flat lamp having the above-mentioned structure, the UV light generated during the gas discharge in the discharge space 11 is used only for exciting the fluorescent layer 14. To improve brightness of the flat lamp and minimize the electric power consumption, efficiency of the UV light must be increased.

In the conventional flat lamps, impurities which deteriorate the operational characteristics of the flat lamps, for example, moisture and organic materials, remain in a discharge space due to various reasons during the manufacturing process. For example, CO₂, CₓH_{y} , and H₂O, etc. remain in the discharge space and these impurities cause problems, such as an increase of the discharge voltage, a shortened lifetime, and deterioration of brightness of the flat lamp. Thus, there is a need to prevent such impurities from remaining in the flat lamp after manufacturing.

In addition, there is a need for various technical developments which can make the flat lamp thinner, brighter, and have lower electrical power consumption.

### SUMMARY OF THE DISCLOSURE

Embodiments of the present disclosure may provide a flat lamp which has increased discharge efficiency and brightness and can utilize UV light in a discharge space in an efficient manner.

According to an aspect of the present disclosure, there may be provided a flat lamp comprising: a bottom substrate; a plurality of barrier ribs on the bottom substrate; a top substrate separated from the bottom substrate by the barrier ribs with a discharge space surrounded by the bottom substrate, the top substrate and the barrier ribs; a plurality of discharge electrodes formed on one side of the top substrate, one side of the bottom substrate, or one side of each of the top substrate and the bottom substrate; a photocatalytic layer which may be formed on at least one of the inner surfaces of the discharge space and generates electrons and holes in response to UV light generated during discharge; and a fluorescent layer which may be formed on the photocatalytic layer and generates visible light in response to the UV light generated during the discharge.

According to another aspect of the present disclosure, there may be provided a flat lamp comprising: a bottom substrate; a plurality of barrier ribs on the bottom substrate; a top substrate separated from the bottom substrate by the barrier ribs with a discharge space surrounded by the bottom substrate, the top substrate and the barrier ribs; a plurality of discharge electrodes formed on one side of the top substrate, one side of the bottom substrate, or one side of each of the top substrate and the bottom substrate; a fluorescent layer which may be formed on at least one of the inner surfaces of the discharge space and generates visible light in response to UV light generated during discharge; and a photocatalytic layer which may be formed on the fluorescent layer and generates electrons and holes in response to the UV light generated during the discharge.

According to still another aspect of the present disclosure, there may be provided a flat lamp comprising: a bottom substrate; a plurality of barrier ribs on the bottom substrate; a top substrate separated from the bottom substrate by the barrier ribs with a discharge space surrounded by the bottom substrate, the top substrate and the barrier ribs; a plurality of discharge electrodes formed on one side of the top substrate, one side of the bottom substrate, or one side of each of the top substrate and the bottom substrate; a photocatalytic layer which may be formed on at least one of the inner surfaces of the discharge space and generates electrons and holes in response to UV light generated during discharge; and a fluorescent layer which may be formed on at least one of the inner surfaces of the discharge space on which the photocatalytic layer is not formed and generates visible light in response to the UV light generated during the discharge.

### BRIEF DESCRIPTION OF THE DRAWINGS

The above and other features and advantages of the present invention will become more apparent by describing in detail exemplary embodiments thereof with reference to the attached drawings in which:

FIG. 1 is a partial perspective view of a conventional flat lamp;

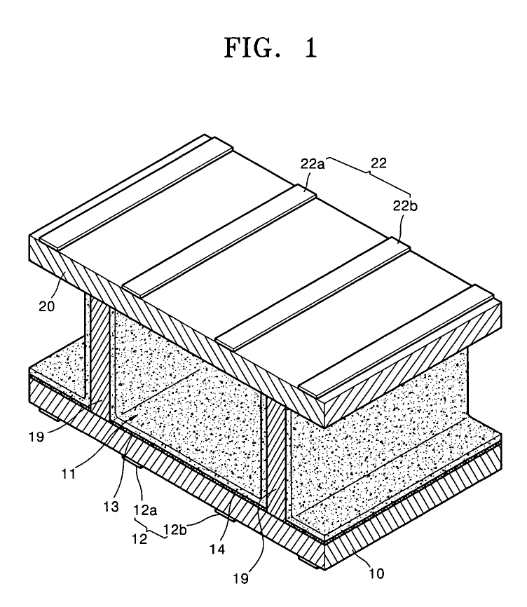

FIG. 2 is a partial perspective view of a flat lamp according to an embodiment of the present disclosure;

FIG. 3 is an exploded partial perspective view of the flat lamp illustrated in FIG. 2;

FIG. 4 is a partial perspective view of a flat lamp according to another embodiment of the present disclosure;

FIG. 5 is an exploded partial perspective view of the flat lamp illustrated in FIG. 4;

FIG. 6 is a partial perspective view of a flat lamp according to another embodiment of the present disclosure; and

FIG. 7 is an exploded partial perspective view of the flat lamp illustrated in FIG. 6.

### DETAILED DESCRIPTION OF EXEMPLARY EMBODIMENTS OF THE DISCLOSURE

Hereinafter, a flat lamp according to embodiments of the present disclosure will be described in detail with reference to the attached drawings.

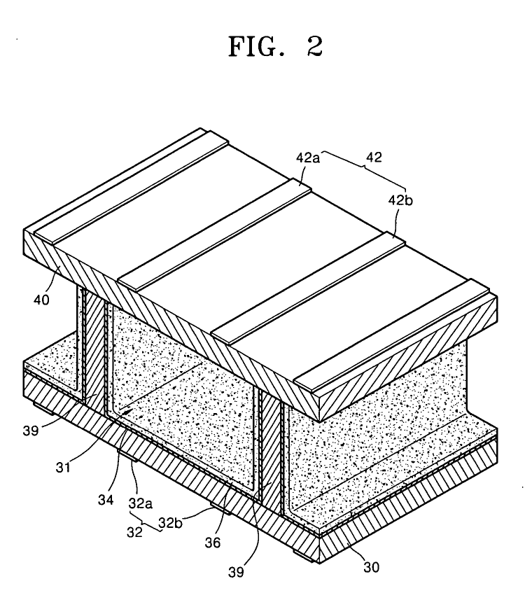

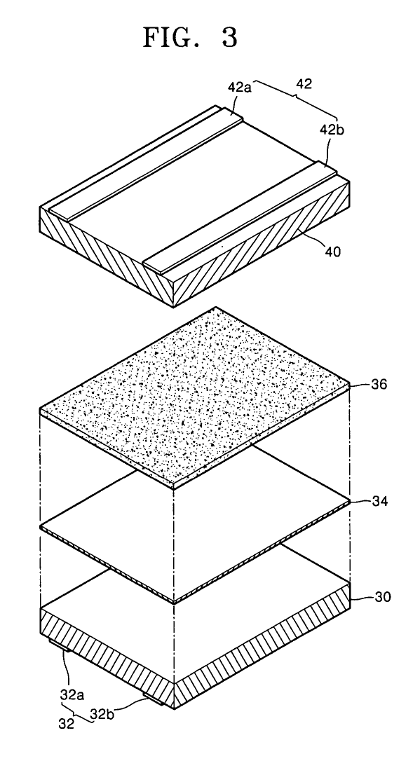

FIG. 2 is a partial perspective view of a flat lamp according to an embodiment of the present disclosure. FIG. 3 is an exploded partial perspective view of the flat lamp illustrated in FIG. 2.

Referring to FIGS. 2 and 3, a bottom substrate 30 and a top substrate 40 may be separated a predetermined distance by a plurality of barrier ribs 39 formed between the bottom substrate 30 and the top substrate 40. A discharge space 31 may be surrounded by the bottom substrate 30, the top substrate 40, and the barrier ribs 39.

The discharge space 31 may be filled with a discharge gas, which may be a mixture of Ne gas and Xe gas. Gas discharge may occur in the discharge space 31.

The flat lamp illustrated in FIGS. 2 and 3 may have a photocatalytic layer 34 formed on at least one of the inner surfaces of the discharge space 31, unlike the conventional flat lamp. Specifically, the photocatalytic layer 34 may be formed on the top surface of the bottom substrate 30 and the lateral surfaces of the barrier ribs 39 and a fluorescent layer 36 may be formed on the photocatalytic layer 34. The fluorescent layer 36 may be formed on portions on which the photocatalytic layer 34 is not formed as well as on the photocatalytic layer 34. That is, the fluorescent layer 36 may be formed on any portion of the inner surfaces of the discharge space 31.

The fluorescent layer 36 may be excited by UV light which may be generated during the gas discharge, producing a visible light. The photocatalytic layer 34 may absorb the UV light generated during the gas discharge and generates electrons and holes.

The electrons increase the electron density of the discharge space 31, thus reducing the discharge voltage and improving the discharge efficiency of the flat lamp.

The electrons and the holes may decompose impurities which deteriorate the operation characteristics of the flat lamps, for example, moisture and organic materials, and thus, may improve the operation characteristics of the flat lamps. As a result, it may be possible to extend the lifetime, reduce the discharge voltage, and improve the discharge efficiency of the flat lamp.

The photocatalytic layer 34 may have a higher reflectance to visible light produced by the fluorescent layer 36 in the discharge space 31 than a reflective layer of a conventional flat lamp, thus increasing brightness of the flat lamp. Accordingly, the conventional reflective layer may be replaced with the photocatalytic layer 34.

In the conventional flat lamp, the UV light generated during the gas discharge in the discharge space 31 is only used for exciting the fluorescent layer. However, in the flat lamp having the photocatalytic layer 34 according to the present embodiment of the present disclosure, the UV light may be used not only for exciting the fluorescent layer 36, but also for catalysing the reaction in the photocatalytic layer 34 to generate electrons and holes. Thus, the UV light in the discharge space 31 may be more efficiently utilized. This may result from an introduction of energy recovery in the flat lamp.

The photocatalytic layer 34 may be made of a material selected from the group consisting of GaP, ZnO₂, Si, SrTiO₃, ZnO, WO₃, SnO₂ and BaTiO₃. The GaP, ZnO₂, Si, SrTiO₃, ZnO, WO₃, SnO₂ and BaTiO₃ may be doped with at least one selected from the group consisting of Pt, Au, Pd, Rh and Ag. The doping with these metal atoms may facilitate electron emission of the photocatalytic layer 34 and make the photocatalytic layer 34 more stable.

The photocatalytic layer 34 may be produced by spray coating, dip coating, spin coating or screen coating. The photocatalytic layer 34 may have a thickness of about 1 to about 500 μm.

In the embodiment illustrated in FIGS. 2 and 3, a photocatalytic layer (not shown) may be further formed on the bottom surface of the top substrate 40 and a fluorescent layer (not shown) may be formed on the photocatalytic layer (not shown). The photocatalytic layer (not shown) formed on the bottom surface of the top substrate 40 may have a low thickness of about 500 to about 10000 Å considering light transmittance of the top substrate 40.

In the embodiment illustrated in FIGS. 2 and 3, a fluorescent layer (not shown) may be formed on at least one of the inner surfaces of the discharge space 31 on which the photocatalytic layer 34 is not formed. Specifically, a fluorescent layer (not shown) may be formed on the bottom surface of the top substrate 40.

Such a modification can be easily understood and induced from the previous embodiment as illustrated in FIGS. 2 and 3 by those skilled in the art.

A plurality of discharge electrodes for the gas discharge may be formed on at lease one of the top surface of the top substrate 40 and the bottom surface of the bottom substrate 30. Specifically, bottom electrodes 32 only may be formed on the bottom surface of the bottom substrate 30, top electrodes 42 may be formed on the top surface of the top substrate 40, or the bottom electrodes 32 and the top electrodes 42 may be respectively formed on the bottom surface of the bottom electrodes 32 and the top surface of the top electrodes 42.

The bottom electrodes 32 may include first bottom electrodes 32a and second bottom electrodes 32b. When a predetermined electrical potential difference is applied between one of the first bottom electrodes 32a and the corresponding second bottom electrode 32b, surface discharge may be induced in the discharge space 31. Similarly, the top electrodes 42 may include first top electrode 42a and second top electrode 42b. When a predetermined electrical potential difference is applied between one of the first top electrodes 42a and the corresponding second top electrode 42b, a surface discharge may be induced in the discharge space 31.

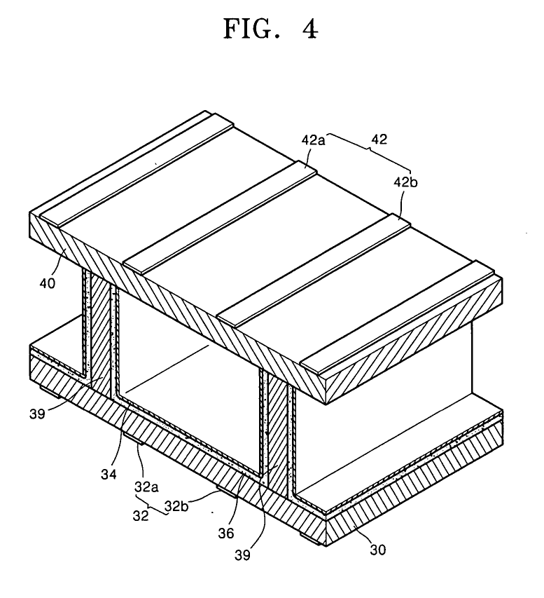

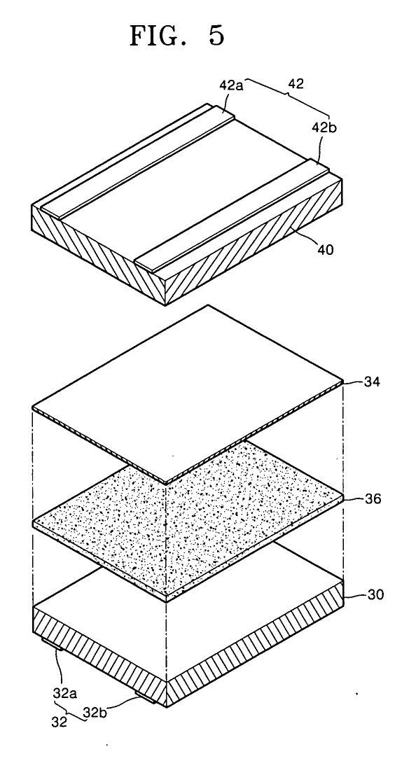

FIG. 4 is a partial perspective view of a flat lamp according to another embodiment of the present disclosure. FIG. 5 is an exploded partial perspective view of the flat lamp illustrated in FIG. 4.

In the embodiment illustrated in FIGS. 4 and 5, only elements which are different from those in the embodiment illustrated in FIGS. 2 and 3 will be described. Like reference numerals refer to like elements.

Referring to FIGS. 4 and 5, the flat lamp may have the same basic structure as the flat lamp as illustrated in FIGS. 2 and 3, except that the fluorescent layer 36 may be formed on at least one of the inner surfaces of the discharge space, and the photocatalytic layer 34 may be formed on the fluorescent layer 36. Specifically, the fluorescent layer 36 may be formed on the top surface of the bottom substrate 30 and the lateral surfaces of the barrier ribs 39 and the photocatalytic layer 34 may be formed on the fluorescent layer 36. The photocatalytic layer 34 may be formed on portions on which the fluorescent layer 36 is not formed as well as on the fluorescent layer 36. That is, the photocatalytic layer 34 may be formed on any of the inner surfaces of the discharge space 31.

In the embodiment illustrated in FIGS. 4 and 5, a fluorescent layer (not shown) may be further formed on the bottom surface of the top substrate 40 and a photocatalytic layer (not shown) may be formed on the fluorescent layer (not shown). The fluorescent layer (not shown) formed on the bottom surface of the top substrate 40 may have a low thickness of about 500 to about 10000 Å considering light transmittance of the top substrate 40.

In the embodiment illustrated in FIGS. 4 and 5, a photocatalytic layer (not shown) may be formed on at least one of the inner surfaces of the discharge space 31 on which the fluorescent layer 36 is not formed. Specifically, only a photocatalytic layer (not shown) may be formed on the bottom surface of the top substrate 40.

Such a modification can be easily understood and induced from the previous embodiment as illustrated in FIGS. 4 and 5 by those skilled in the art.

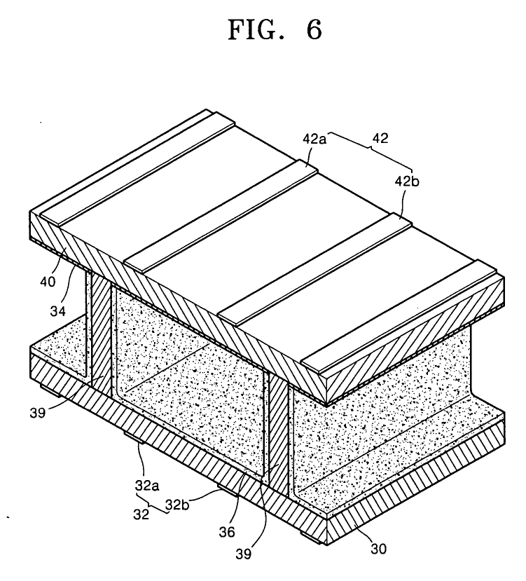

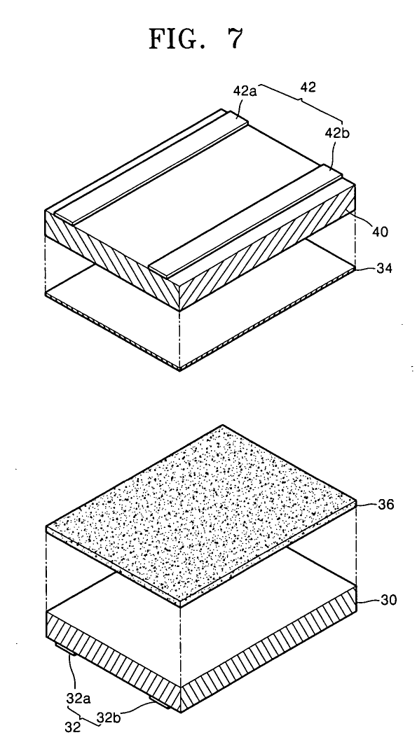

FIG. 6 is a partial perspective view of a flat lamp according to another embodiment of the present disclosure. FIG. 7 is an exploded partial perspective view of the flat lamp illustrated in FIG. 6.

In the embodiment illustrated in FIGS. 6 and 7, only elements which are different from those in the embodiment illustrated in FIGS. 2 and 3 will be described. Like reference numerals refer to like elements.

Referring to FIGS. 6 and 7, the flat lamp has the same basic structure as the flat lamp as illustrated in FIGS. 2 and 3, except that the photocatalytic layer 34 may be formed on at least one of the inner surfaces of the discharge space 31 and the fluorescent layer 36 may be formed on at least one of the inner surfaces of the discharge space 31 on which the photocatalytic layer 34 is not formed. Specifically, the photocatalytic layer 34 is formed on the bottom surface of the top substrate 40 and the fluorescent layer 36 is formed on the top surface of the bottom substrate 30 and the lateral surfaces of the barrier ribs 39.

The flat lamp according to the present disclosure may have the following effects.

First, the photocatalytic layer may absorb the UV light generated during the gas discharge and generates electrons and holes. The electrons may increase the electron density in the discharge space during the gas discharge, thus reducing the discharge voltage and improving the discharge efficiency of the flat lamp.

Second, the electrons and the holes may decompose impurities which deteriorate the operation characteristics of the flat lamps, for example, moisture and organic materials, and thus, may improve the operation characteristics of the flat lamps. As a result, it may be possible to extend the lifetime, reduce the discharge voltage, and improve the discharge efficiency of the flat lamp.

Third, the photocatalytic layer may have a higher reflectance to visible light produced by the fluorescent layer in the discharge space than a reflective layer of a conventional flat lamp, thus increasing brightness of the flat lamp. Accordingly, the conventional reflective layer may be replaced with the photocatalytic layer.

Fourth, whereas in the conventional flat lamp, the UV light generated during the gas discharge in the discharge space is only used for exciting the fluorescent layer, in the flat lamp having the photocatalytic layer according to embodiments of the present disclosure, the UV light may be used not only for exciting the fluorescent layer, but also for catalysing the reaction in the photocatalytic layer to generate electrons and holes. Thus, the UV light in the discharge space may be more efficiently utilized. This results from the introduction of energy recovery to the flat lamp.

While the present invention has been particularly shown and described with reference to exemplary embodiments of the disclosure, it will be understood by those of ordinary skill in the art that various changes in form and details may be made therein without departing from the spirit and scope of the present invention as defined by the following claims.

What is claimed is:

1. A flat lamp comprising:
a bottom substrate;
a plurality of barrier ribs on the bottom substrate;
a top substrate separated from the bottom substrate by the barrier ribs with a discharge space surrounded by the bottom substrate, the top substrate and the barrier ribs;
a plurality of discharge electrodes formed on one side of the top substrate, one side of the bottom substrate, or one side of each of the top substrate and the bottom substrate;
a photocatalytic layer which is formed on at least one of the inner surfaces of the discharge space and generates electrons and holes in response to UV light generated during discharge; and
a fluorescent layer which is formed on the photocatalytic layer and generates visible light in response to the UV light generated during the discharge.

2. The flat lamp of claim 1, wherein the photocatalytic layer is made of a substance selected from the group consisting of GaP, ZnO₂, Si, SrTiO₃, ZnO, WO₃, SnO₂ and BaTiO₃.

3. The flat lamp of claim 2, wherein the substance selected from the group consisting of GaP, ZnO₂, Si, SrTiO₃, ZnO, WO₃, SnO₂ and BaTiO₃ is doped with at least one metal selected from the group consisting of Pt, Au, Pd, Rh, and Ag.

4. The flat lamp of claim 2, wherein the photocatalytic layer is produced using a method selected from the group consisting of spray coating, dip coating, spin coating and screen coating.

5. The flat lamp of claim 2, wherein the photocatalytic layer has a thickness of about 1 to about 500 μm.

6. The flat lamp of claim 2, wherein the photocatalytic layer formed on the inner surface of the top substrate has a thickness of about 500 to about 10000 Å.

7. The flat lamp of claim 1, wherein the fluorescent layer is further formed on at least one of the inner surfaces of the discharge space on which the photocatalytic layer is not formed.

8. A flat lamp comprising:
a bottom substrate;
a plurality of barrier ribs on the bottom substrate;
a top substrate separated from the bottom substrate by the barrier ribs with a discharge space surrounded by the bottom substrate, the top substrate and the barrier ribs;
a plurality of discharge electrodes formed on one side of the top substrate, one side of the bottom substrate, or one side of each of the top substrate and the bottom substrate;
a fluorescent layer which is formed on at least one of the inner surfaces of the discharge space and generates visible light in response to UV light generated during discharge; and
a photocatalytic layer which is formed on the fluorescent layer and generates electrons and holes in response to the UV light generated during the discharge.

9. The flat lamp of claim 8, wherein the photocatalytic layer is made of a substance selected from the group consisting of GaP, ZnO₂, Si, SrTiO₃, ZnO, WO₃, SnO₂ and BaTiO₃.

10. The flat lamp of claim 9, wherein the substance selected from the group consisting of GaP, ZnO₂, Si, SrTiO₃, ZnO, WO₃, SnO₂ and BaTiO₃ is doped with at least one metal selected from the group consisting of Pt, Au, Pd, Rh and Ag.

11. The flat lamp of claim 9, wherein the photocatalytic layer is produced using a method selected from the group consisting of spray coating, dip coating, spin coating and screen coating.

12. The flat lamp of claim 9, wherein the photocatalytic layer has a thickness of about 1 to about 500 μm.

13. The flat lamp of claim 9, wherein the photocatalytic layer formed on the inner surface of the top substrate has a thickness of about 500 to about 10000 Å.

14. The flat lamp of claim 8, wherein the photocatalytic layer is further formed on at least one of the inner surfaces of the discharge space on which the fluorescent layer is not formed

15. A flat lamp comprising:
a bottom substrate;
a plurality of barrier ribs on the bottom substrate;
a top substrate separated from the bottom substrate by the barrier ribs with a discharge space surrounded by the bottom substrate, the top substrate and the barrier ribs;
a plurality of discharge electrodes formed on one side of the top substrate, one side of the bottom substrate, or one side of each of the top substrate and the bottom substrate;
a photocatalytic layer which is formed on at least one of the inner surfaces of the discharge space and generates electrons and holes in response to UV light generated during discharge; and
a fluorescent layer which is formed on at least one of the inner surfaces of the discharge space on which the photocatalytic layer is not formed and generates visible light in response to the UV light generated during the discharge.

16. The flat lamp of claim 15, wherein the photocatalytic layer is made of a substance selected from the group consisting of GaP, ZnO₂, Si, SrTiO₃, ZnO, WO₃, SnO₂ and BaTiO₃.

17. The flat lamp of claim 16, wherein the substance selected from the group consisting of GaP, ZnO₂, Si, SrTiO₃, ZnO, WO₃, SnO₂ and BaTiO₃ is doped with at least one metal selected from the group consisting of Pt, Au, Pd, Rh and Ag.

18. The flat lamp of claim 16, wherein the photocatalytic layer is produced using a method selected from the group consisting of spray coating, dip coating, spin coating and screen coating.

19. The flat lamp of claim 16, wherein the photocatalytic layer has a thickness of about 1 to about 500 μm.

20. The flat lamp of claim 16, wherein the photocatalytic layer formed on the inner surface of the top substrate has a thickness of about 500 to about 10000 Å.
